(19) United States
(12) Patent Application Publication
(10) Pub. No.: US 2021/0276902 A1
(43) Pub. Date: Sep. 9, 2021

(54) WASTEWATER TREATMENT SYSTEM

(71) Applicant: Pulsed Burst Systems, LLC, Milwaukee, WI (US)

(72) Inventors: Kenneth E. Neu, Hartford, WI (US); Charles Otis, Milwaukee, WI (US); Trevor Ghylin, Wauwatosa, WI (US)

(73) Assignee: Pulsed Burst Systems, LLC, Milwaukee, WI (US)

(21) Appl. No.: 17/273,916

(22) PCT Filed: Sep. 6, 2019
(86) PCT No.: PCT/US2019/050101

§ 371 Date: Mar. 5, 2021

Related U.S. Application Data
(60) Provisional application No. 62/728,475, filed on Sep. 7, 2018.

(51) Int. Cl. C02F 3/20; C02F 3/30; B01F 13/02

(52) U.S. Cl. CPC C02F 3/20; C02F 3/302; B01F 2215/0052; C02F 2203/002; C02F 2203/006; B01F 13/0255

(57) ABSTRACT

A wastewater treatment system includes a blower providing air to an aerator and a low pressure pulsed air mixer. The invention generally relates to a wastewater treatment system and more particularly to a wastewater treatment system to eliminate biological and nutrient contaminants from wastewater.

### CROSS-REFERENCE TO RELATED PATENT APPLICATIONS

This application claims the benefit of U.S. Provisional Application No. 62/728,475 entitled WASTEWATER TREATMENT SYSTEM filed Sep. 7, 2018 incorporated herein by reference in its entirety.

### BACKGROUND

The invention generally relates to a wastewater treatment system and more particularly to a wastewater treatment system to eliminate biological and nutrient contaminants from wastewater.

### SUMMARY

A wastewater treatment system including a blower providing air to aerators and a low pressure pulsed air mixer.

A wastewater treatment system including a blower providing air to aerators; a low pressure pulsed air mixer and a low pressure pulsed air pump.

### BRIEF DESCRIPTION OF THE DRAWINGS

FIG. 1 is a schematic view of a wastewater treatment system.

FIG. 2 is a schematic view of a prior art wastewater treatment system.

FIG. 3A is a schematic view of a wastewater treatment system.

FIG. 3B is a schematic view of a wastewater treatment system.

FIG. 3C is a schematic view of a wastewater treatment system.

FIG. 4A is pulsed air mixer for use with an aeration system.

FIG. 4B is a pulsed air mixer secured to a holder.

FIG. 5 is a pulsed air mixer for use with an aeration system.

FIG. 6 is a pulsed air mixer movable within a fluid tank.

### DETAILED DESCRIPTION OF THE EXAMPLE EMBODIMENTS

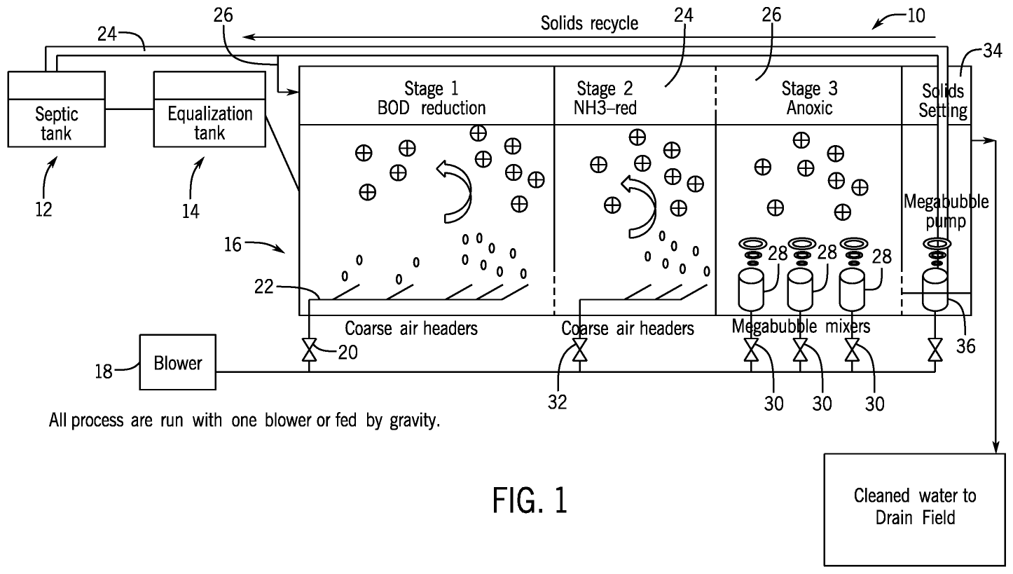

Referring to FIG. 1. A wastewater treatment system 10 includes a septic tank 12 holding wastewater to be treated. In one embodiment septic tank 12 may also be a clarifier, Dissolved Air Flotation (DAF) Thickener, Cloth or metal screening device, Vortex Solids Separator or any other primary debris removal device as is known in the art meant to separate or settle course solids and floatables from the wastewater fluid stream. Fluid from the primary solids separation device or septic tank 12 flows to an equalization tank 14 via gravity or other known methods in the art, however, if surge flow control is not implemented, fluid flow may proceed to further treatment without the surge flow equalization step.

In one embodiment when surge flow equalization is implemented, the wastewater in the equalization tank equalizes the flow of wastewater to allow a steady flow from the equalization tank 14 to a first stage 16. First stage tank 16 may be a portion of a tank or stand-alone tank. In the first stage tank 16 the pollution load of the waste water is reduced through aeration by the introduction of fine and/or coarse bubbles into the first stage tank 16. As is known in the art, aeration provides oxygen for aerobic respiration of microbes or other biological agents to break down organic waste in wastewater. In one embodiment, fine bubbles are defined as small bubbles with a diameter of 3 mm or less, while coarse bubbles in one embodiment are between 3 mm and 50 mm. The fine and and/or coarse bubbles provide the oxygen required in the first stage tank 16.

The bubbles are introduced into the first stage tank 16 via an air blower 18 blowing air through a valve 20 and fine and/or coarse bubbles are created within first stage tank 16 with an air distributer 22. As is known in the art, an air distributer may include apertures in a pipe and/or a specially designed air header with a wide variety of styles of air diffusion apparatus to create the desired bubble size.

In one embodiment, A, microbial flocs or suspended biological growth-typically called activated sludge. B, biofilm attached to surfaces typically called fixed biological film—the biofilm adheres to a fixed surface area within the tank, or particles of sponge, plastic or other biofilm carrier elements (plastic beads, wafers, etc.), known in the art as a moving bed bioreactor (MBBR). C, where a combination of an activated sludge and fixed film (A & B) which are microbial flocs are free to circulate within the entire reactor, and where the fixed film media stays within its tank through screening, known as Integrated Fixed Activated Sludge (IFAS). In the first stage tank 16 the microbes and carrier elements (if applicable) move within the wastewater by the bubbles and/or a mechanical mixer such as a rotating blade or other mechanical mixers known in the art. Mechanical mixers are typically electrically powered. In one embodiment no mechanical mixing is employed in the first stage tank 16, as aeration is used (typically coarse bubble) and causes enough agitation.

Once the wastewater has been treated within first stage tank 16, wastewater flows to a second stage tank 24 which may be a portion of tank 16 with baffles or may be a separate tank. In the second stage tank 24 the wastewater is further treated with further biological treatment to convert ammonia within the wastewater to nitrate. Fine and/or coarse bubbles are introduced into second stage tank 24 by blower 18 via a second valve 32 and air header. In one embodiment the air bubbles introduced into the second stage tank 24 may be of a different size and/or rate than the size and/or rate of the bubbles introduced into first stage tank 16. In one embodiment a second blower independent of the first blower 18 may be used to pump air into the second stage tank 24.

Once wastewater has been treated in second stage tank 24, the wastewater flows to a third stage tank 26 which may be a section of a larger tank including either one or both of the first stage tank 16 and the second stage tank 24. Third stage tank includes one or more pulsed air mixer 28 that provide intermittent large bubbles formed within the pulsed air mixer 28. This is in contrast to a valve that opens and closes intermittently, as air fed to pulsed air mixers is continuous. In one embodiment the number of stages may vary. In one embodiment there may be more than three stages, depending on the desired treatment. A pulsed air mixer is known in the art and one such pulsed air mixer that may be used is described in US patent publication No 2014/0246105 entitled Non-Clogging Airlift Pumps and Systems and Methods Employing the Same which is hereby incorporated by reference in its entirety. Another pulsed air device is disclosed in U.S. patent application No. 62/656,342 entitled Bubble Generator which is incorporated herein by reference in its entirety. Pulsed Burst Systems LLC manufactures and sells a low pressure pulsed air mixer under the trademark Megabubble.

In one embodiment the pulsed air mixer receives air from blower 18 generator receiving air via third valve or valves 30. In one embodiment pulsed air mixer device receives air via a blower separate from the blower 18 providing air to first stage tank 16 and/or second stage tank 24. Continuous low pressure air accumulates in pulsed air mixers 28 therein and intermittently releases a large bubble. As illustrated in FIG. 1, pulsed air mixer 28 is positioned within third stage tank 26. In one embodiment pulsed air mixer 28 provides intermittent large bubbles having at least one bubble having a diameter greater than 50 mm. In one embodiment the diameter of the large bubble is between 50 mm and 200 mm. In one embodiment the diameter of the large bubble is greater than 200 mm.

In one embodiment valves 20, 32 and 30 are valves that are fixed or may be adjusted. In one embodiment the adjustment may be mechanical but not controlled electronically. In one embodiment the adjustment of valves 20, 32 and 30 may be controlled electromechanically via a controller.

Once the wastewater has been treated in third stage tank 26 the wastewater flows to a solids settling tank 34 or other equipment known in the art to separate biologically generated microbes from the cleaned water. In one embodiment a pulsed air pump 36 provides intermittent large bubbles in the solids settling tank 34 that receives air via blower 18 and or a separate blower that provides air only to the low pressure pulsed air pump within the solids settling tank or to the second stage tank and/or third stage tank. The large bubbles created by the pulsed air pump 36 are directed through a pipe. The large bubbles act as a piston and/or siphon to drive the solid portions of the wastewater along with some wastewater via a conduit to the septic tank, biosolids holding tan clairifier and or first stage tank to retreat the wastewater. In one embodiment, multiple pumps can be run with varying rates of continuous air for movement of solids and water to different locations, i.e. recycle of sludge, or pumping out of the system to a solids holding tank for scheduled removal. Clean water from the wastewater treatment system is allowed to flow via a conduit to a drain field for reincorporation to soil and groundwater, to surface water, or to other destinations such as irrigation or re-use. In one embodiment the cleaned wastewater may be further polished via tertiary processes such as, but not limited to, filtration or adsorption.

In one embodiment a pulsed air mixer 28 may be used in the first stage tank 16, and/or second stage tank 24 instead of or in addition to a mechanical mixer along with the fine and/or coarse air bubbles. The fine and/or coarse air bubbles providing air for aeration purpose and the pulsed air mixer 28 providing mixing to assist in the circulation of the fine and/or coarse air bubbles. In one embodiment the fine and/or coarse air bubbles and the pulsed air mixer is powered solely by the blower 18. In one embodiment no electromechanical mixer such as a blade or propeller mixer is used in either of the first stage tank 16, second stage tank 24 and third stage tank 26. Stated another way, in one embodiment all aeration and mixing is accomplished solely via a blower without an electromechanical mixer; the same blower provides air to the fine and/or coarse air headers and the pulsed air mixer.

In one embodiment no electrical pump or mixer is used in the first stage tank 16, second stage tank 24 and third stage tank 26. In this embodiment only a single blower is required to power the aeration, mixing and pumping of the wastewater within the system. In one embodiment blower 18 is a low pressure blower providing air at a pressure slightly exceeding the static pressure at the depth the air is being introduced within the wastewater tank. In one embodiment, the pressure of the air at the air header (gauge pressure) is under 25 psi higher than the static pressure at the air header depth. In one embodiment the pressure of the air at the air header is under 20 psi and greater than the static pressure. In one embodiment the pressure of the air at the air header is under 15 psi and greater than the static pressure. In one embodiment the pressure of the air at the air header is under 10 psi and greater than the static pressure. In one embodiment the pressure of the air at the air header is under 5 psi and greater than the static pressure. In one embodiment the pressure of the air at the air header is under 2 psi greater than the static pressure.

In one embodiment, low pressure air between 2-25 psi over the static pressure is introduced to wastewater is typically used worldwide within a variety of treatment processes for establishment of aerobic microbes which have the ability to clean used water of contaminants. The air is introduced within the wastewater by various means and methods, most known in the art. Some treatment steps require no air, simply mixing.

In one embodiment the air pressure provided is 25 psi or less over the static pressure. So by way of example if the static pressure is 0.45 psi per foot depth in water (excluding atmospheric pressure, or gauge pressure) then at 10 feet, the air pressure provided needs to greater than 4.5 psi. of static pressure so that air will flow against the fluid pressure at that depth in the tank. In this example, the total PSI to get air to that depth should be between 4.5—and 29.5 psi. In one embodiment the air pressure provided should be lower than 25 psi+static air pressure as described above.

In one embodiment, the use of low pressure air (the air typically used in most wastewater treatment plants) for supplying pulsed air mixers in which they accumulate and release large volumes of air forming large rapidly rising bubble(s) within the treatment tank or vessel. The large bubbles and mixing therein then creates a more efficient, effective blending of contents within aerobic zones or tanks—in conjunction with aeration.

The use of and incorporation of this low pressure pulsed air mixing device within wastewater treatment processes enables designers and users (operations personnel) to create specific treatment zones (low medium or high mixing intensity and/or dissolved oxygen (DO)), with tanks or portions of tanks—simply using plant air, and possibly without the need for expensive segregation of treatment zones with material structures known in the art as baffles or bulkheads, or with separate tanks. When moving carrier elements (plastic, sponge, etc.) are used to grow fixed film microbes such as in MBBR treatment methods, the pulsed air device can be used solely or in conjunction with aeration to mix, blend and move carrier elements and microbes within a single or plurality of various treatment stages. In one embodiment even though air is being pumped the aeration efficiency of pulsed air mixers is very low. However, in conjunction with other types of bubbles such as fine or coarse bubbles, it increases the efficiency of the aeration by moving water and solids around more effectively.

When a large bubble generator is coupled with a gas transfer device (i.e. fine bubble diffusers) there is a synergistic effect that improves aeration efficiency due to the velocity gradients created by the large bubbles. Additionally, the inclusion of large bubble generators (i.e. the mixing system) with conventional aeration devices such as fine bubble diffusers (i.e. the aeration system) allows the aeration system to be turned down or turned off completely (transiently or permanently depending on location) while still ensuring adequate mixing. This feature allows for the creation of low oxygen, anoxic and anaerobic zones (devoid of oxygen) that are well-mixed and can significantly enhance the biological removal of nitrogen and phosphorus, key nutrient pollutants that cause eutrophication and degradation of surface waters when released to the environment. By optimizing the biological removal of nitrogen and phosphorus this system can help treatment plants reduce chemical consumption for alkalinity adjustment and phosphorus removal. Allowing aeration to turn down or turn off completely vastly improves the energy efficiency of the system.

The low pressure pulsed air device, in this embodiment, pump 36, can be used in a different device configuration to pump fluids, such as water with small to medium sized debris or biosolids. Uses include transfer from surge flow equalization tanks to active treatment zones, waste biosolids removal from clarification zones, etc.

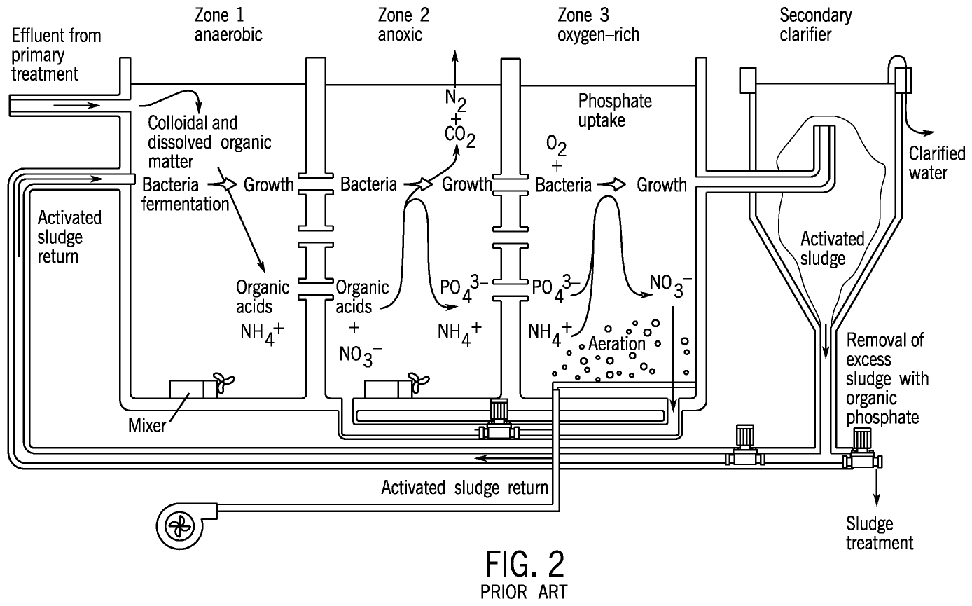

Referring to FIG. 2 a prior art wastewater treatment system includes several tanks for the processing of wastewater, and various recycle loops. This embodiment is only one example of a wastewater treatment plant, as other embodiments may have different locations of tanks or add/omit certain tanks depending on the processes and/or completeness of treatment that is desired. In the embodiment of FIG. 2, wastewater enters from the top left, where it enters an anaerobic tank (no oxygen as electron donor), followed by an anoxic tank (no free oxygen, but presence of nitrate, NO₃−), and an aerobic/oxic tank where the majority of carbon oxidation and bacterial growth occur. In typical wastewater treatment plants known in the art, the anoxic and anaerobic zones are mixed by mechanical means—typically a propeller type mixer or pump with submersible motor. Aeration in the oxic tank is achieved typically by fine or coarse bubble mixing, with air provided by a blower—the availability of oxygen is very important, but this aeration also provides mixing for the bacteria. FIG. 2 shows a recycle loop between the oxic tank and the anoxic tank, which is where nitrified wastewater to be returned to the anoxic tank—this is typically pumped mechanically. The clarifier separates the bacteria from treated wastewater, where the clarified wastewater leaves the plant for discharge or further treatment. The settled sludge is returned and wasted, ratios depending on system requirements. This recycle or wasting is also typically pumped via mechanical means.

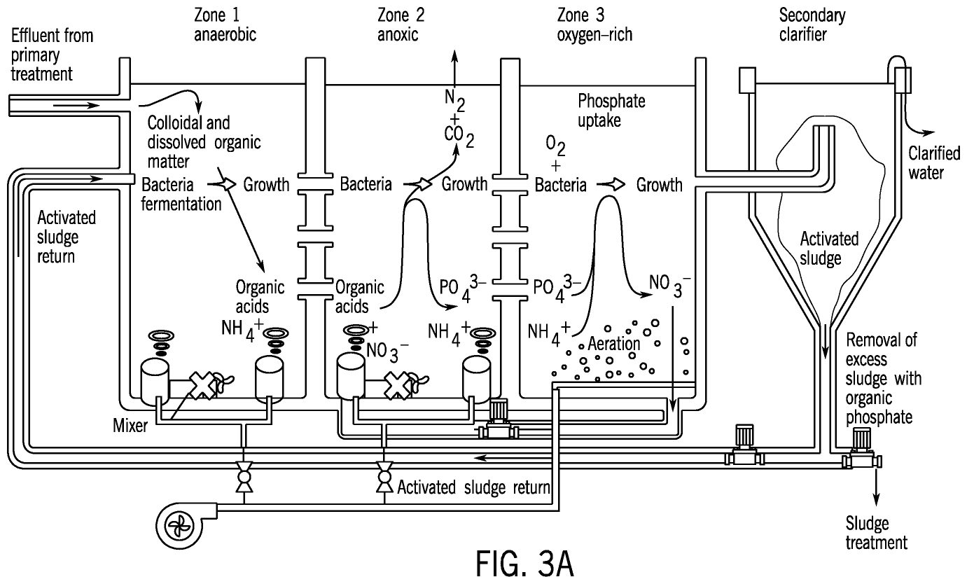

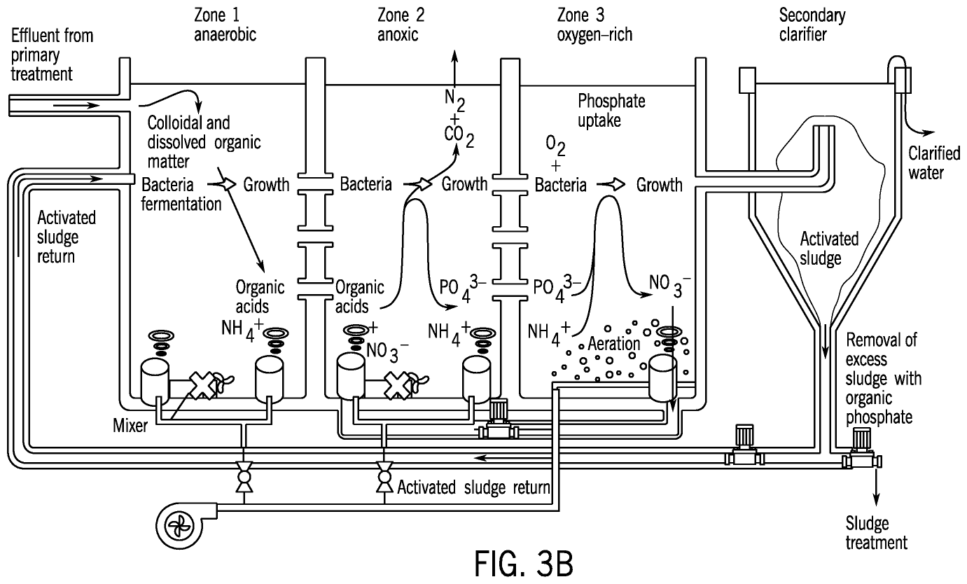

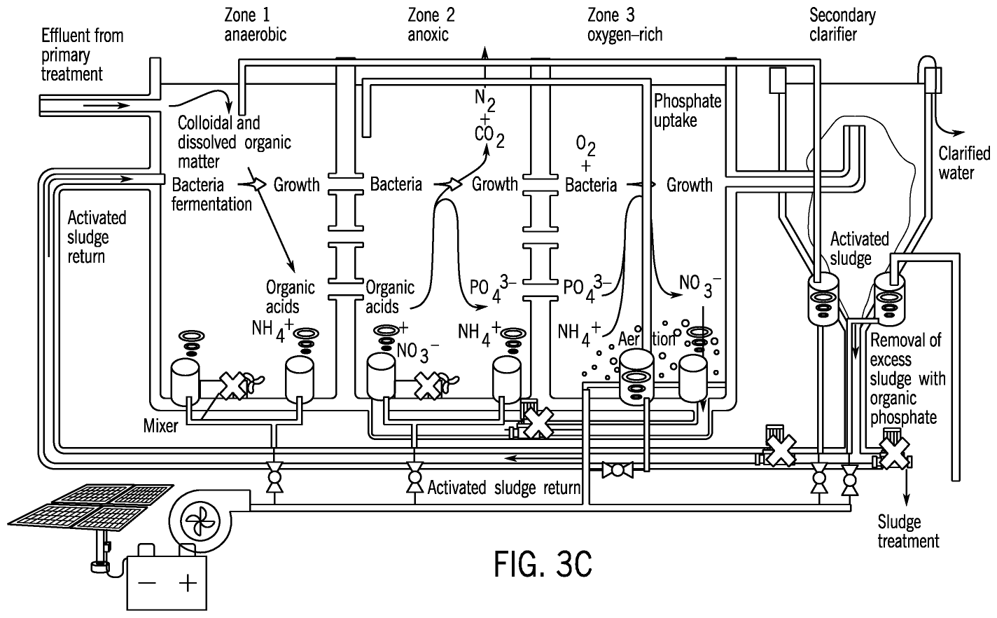

Referring to FIG. 3A a wastewater treatment system with pulsed air mixers instead of mechanical mixers includes the same tanks as typical in the art, with the same purposes. Despite using air, the bubbles from a pulsed air mixer add virtually no oxygen to the water due to the relatively small surface area and speed at which they travel through the water column.

In another embodiment shown in FIG. 3B, pulsed air mixers are added to the aeration basin as well as the anoxic and anaerobic zones. This unit may collect air directly from a dedicated line, or be placed over existing aerators to collect air passively. The increased mixing in the aerobic zone may increase the treatment efficiency by mixing solids more effectively and moving oxygen rich water to lower in the water column than aeration alone.

In another embodiment, shown in FIG. 3C, low pressure pulsed air mixers and pumps replace and augment the processes that would otherwise be done by mechanical means. In this embodiment, mechanical means for mixing and pumping are replaced by low pressure bubble mixers and pumps. Due to the high volume/surface area ratio, very little oxygen I transferred to the wastewater despite adding air to anoxic or anaerobic zones. Pulsed air pumps are predictable and efficient, and can be used to replace recycle and wasting solids from the system. This differs from the art (FIG. 2) by eliminating the need for various motors for pumps and mixers, replacing with air mixers which have no moving parts. Valves can be used to either manually adjust the air flow, or an electromechanical feedback loop is able to control the flow of low pressure air into each (or a bank) of pulsed air mixers and pumps, controlling the flow of air and thus controlling the accumulation time of each bubble. Additionally, since they are powered only by air, there are no electrical components in the water. The system in FIG. 5 requires minimal maintenance as there are no moving parts in contact with the water. Due to the removal of electric motors, there is only low voltage equipment to run (control panel, electromechanical valves if needed), which makes this system predictable and steady in energy consumption. Due to this predictability, alternative means of powering the system may be employed, such as using solar panels or other alternative energy sources. The system may or may not be practical in full scale systems, but very practical in small scale decentralized systems, such as MBBR and IFAS systems, especially where qualified technicians are expensive or in short supply.

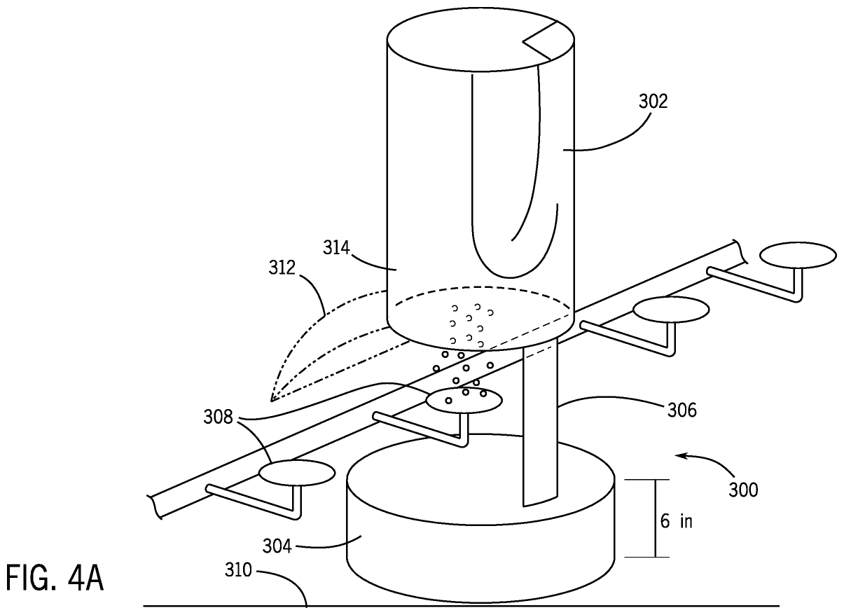

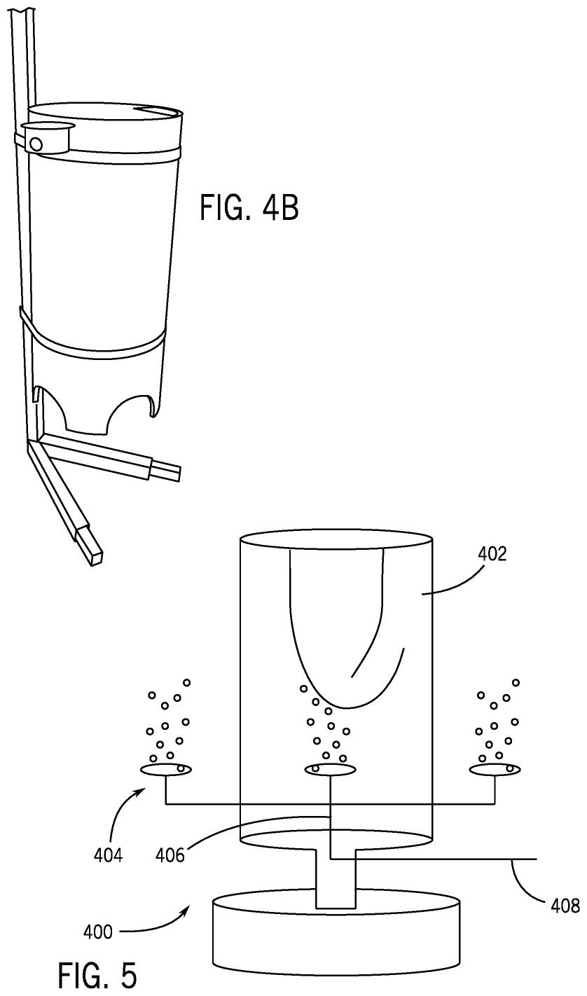

Referring to FIG. 4A a passive pulsed air mixer 300 includes a pulsed air mixer 302 portion described in pending U.S. Application No. 62/656,342 entitled Bubble Generator. However other pulsed air mixer designs that provide intermittent pulsed air bubbles may also be used with passive pulsed air mixer 300. For example, the pulsed air mixer described in published application No 2014/0246105 as well as other pulsed air devices known in the art may be used.

Referring to FIG. 4A a passive pulsed air mixer 300 further includes a base portion 304 which is held to the bottom of a tank 310. In one embodiment base portion 302 is anchored to the tank with mechanical fastener. In one embodiment base portion 304 includes ballast such as concrete or other non-corroding material having sufficient weight to maintain passive pulsed air mixer 302 in a fixed position relative to the bottom of the tank when pulsed air mixer 302 has the maximum volume of air in the pulsed air cycle. A riser member portion 306 extends from base portion 304 and support pulsed air mixer 302 a distance above base portion 304. The distance between base portion 304 and pulsed air mixer 302 is sufficient to allow an air header 308 to fit there between. Air header 308 introduces air from a low pressure blower into the region between base portion 304 and pulsed air mixer 302. Air released from air header 308 is received within pulsed air mixer 300. Air accumulates within pulsed air mixer 302 from air head 308 until the air reaches the critical level and a large bubble is released as described in U.S. Provisional application No. 62/656,342. The system passive pulsed air mixer 300 is defined as passive because no air is directly connected to the pulsed air mixer 302, rather pulsed air mixer 302 passively receives air directly from an airhead 308. In one embodiment airhead 308 may be part of an existing wastewater treatment system providing fine or coarse bubbles. Passive pulsed air mixer 300 may be place adjacent to the airhead 308 such that the fine or coarse bubbles released form the airhead 308 are received within pulsed air mixer 302. The mixing from these passive mixers is to augment the mixing of the tanks such that the volume of air required by the aeration gallery may be lowered. In many cases, such as with WI DNR, horsepower requirements are mandated in design such as to keep solids in suspension, even if the bacteria does not require as much oxygen—the passive mixers put in place may allow operators to reduce the amount of air into a bank of aeration headers to reduce overall electricity usage (blower) while sustaining adequate mixing.

In one embodiment a skirt member 312 may added to a bottom portion of pulsed air mixer 302 that extends radially outwardly from the outer housing 314 of pulsed air mixer 302 to assist in capturing additional air from airhead 308.

Referring to FIG. 4B, an early prototype of a passive pulsed air mixer. This embodiment shows a pulsed air mixer placed on a riser. In one embodiment, the riser can be separate from the pulsed air mixer and made out of a separate material and fastened into place. In one embodiment, the riser may be cut out of the same material as the mixer body, in this case PVC pipe—the PVC pipe is rigid enough to sustain repeated bursts and is non corrosive. In the latter embodiment, the pipe may be cut 50% to 80% in order to facilitate the height of the air headers already in situ as shown in FIG. 4B. The bottom piece, as shown in prototype in FIG. 4B, may be either fastened to the ground or set in concrete as ballast such that it may be set in place.

Referring to FIG. 5 an aerator and pulsed air mixer device includes both integrated aeration, either fine bubble or coarse bubble air headers and a pulsed air mixer in a stand-alone unit. In one embodiment, an air line 408 is fed by an external blower, which may be valved. In one embodiment air line 408 enters the pulsed air mixer. In one embodiment air line 408 connects to the outside of pulsed air mixer 400. Air line 408 is split by a manifold 406 and sends separate air lines to aeration headers 404, one of which rests inside pulsed air mixer 400 underneath the pulsed air mechanism 402. Air is fed to both air headers 404 which produce fine or coarse bubbles. The air header residing in the interior of the pulsed air mixer 400 produces air which is accumulated in the unit. This in turn allows the standalone unit to provide both aeration via the external aeration headers and large bubble pulsed air mixing in one unit. The large bubbles produced allow for much greater mixing effect than prior art devices without large bubbles.

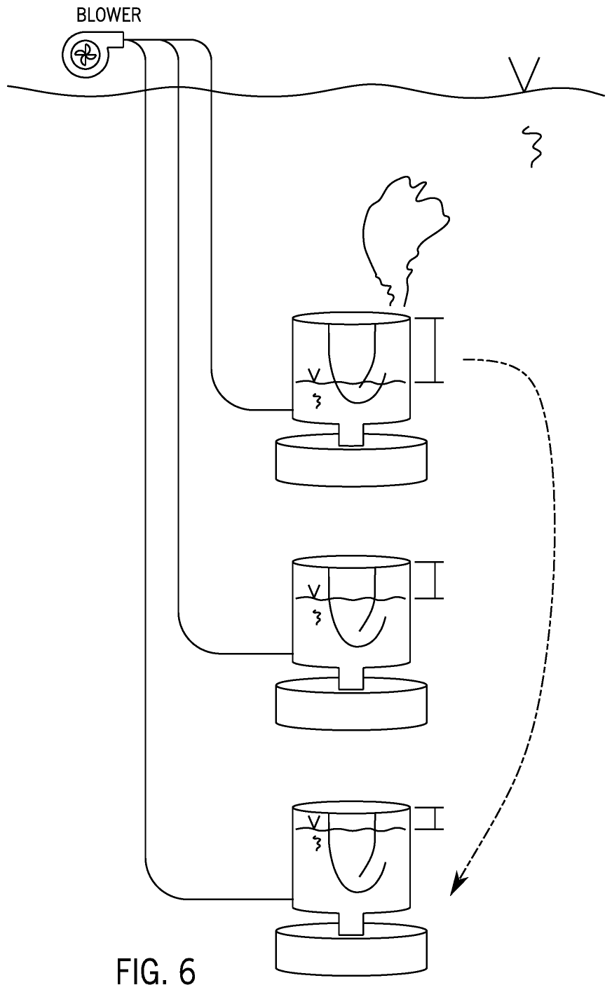

Referring to FIG. 6 a pulsed air mixer system that moves from a first lower position to a second higher position within a fluid prior to releasing air includes a pulsed air mixer which has roughly equal or slightly less ballast than the fully accumulated pulsed air mixer has buoyancy. The pulsed air mixer devoid of air will sit on the bottom of a given tank. As air accumulates, the buoyancy overcomes the ballast and the entire unit rises up through the water column until A, the air expands and causes the pulsed air mixer to evacuate, B, the unit is filled past the evacuation point by the external air source, or C, a combination of both A and B. After the bubble is released, the pulsed air mixer sinks back to the bottom of the tank.

Another application uses low pressure pulsed air mixer(s) and pump(s). The key distinguishing factor from prior art is that the same source air supply or similar low pressure air supply can be used for pulsed air mixing and pumping. Lower pressure is more clearly defined as air pressure just slightly above static water column pressure at any depth. This is uniquely different than prior art pulsed air devices or generators which require much higher pressure than only slightly higher than static pressure—to operate properly. The ability to use only low pressure air for pulsed air mixing and pumping is unique in the industry due to less equipment, less energy required—but with similar or more beneficial effects for wastewater treatment. Several variations of these advances of the state of the art are described. Each application of the low pressure pulsed air mixing and pumping coupled with existing air sources or similar pressure independent air source—is unique to the site utilized. There may be low pressure pulsed air mixing and/or pumping applications yet undescribed in the worldwide realm of wastewater treatment. However, the broad description within this application is meant to cover various applications using general principals described herein.

In one embodiment a wastewater system includes a blower providing air to an aerator; a low pressure pulsed air mixer and a low pressure pulsed air pump. In one embodiment the wastewater system further includes a moving bed biofilm reactor (MBBR) process, with variable carrier element filling degree from 0-100%. In one embodiment the variable carrier element filling degree is between 5-95%. In one embodiment a wastewater system of single or multiple treatment zones of suspended, fixed or combined microbial processes, includes a blower providing air to an aerator and a low pressure pulsed air mixer. In a further aspect the wastewater system may also incudes a first stage tank, wherein the aerator or low pressure pulsed air mixer, or both aerator and low pressure pulsed air mixer is located in the first stage tank.

The tank disclosed herein may there are more that 3 stages or zones. In one embodiment there are as many as 6-10 treatment zones per treatment train line.

Although the present disclosure has been described with reference to example embodiments, workers skilled in the art will recognize that changes may be made in form and detail without departing from the spirit and scope of the defined subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described is manifestly intended to be as broad as possible. For example, unless specifically otherwise noted, the definitions reciting a single particular element also encompass a plurality of such particular elements.

A wastewater treatment system includes a blower or multiple blowers providing air to an aerator and a low pressure pulsed air mixer, a low pressure pulsed air pump or both. The point being that aeration, mixing and pumping can be accomplished with low pressure air within the majority of typical wastewater treatment processes. This concept is relatively new to the industry. This method has many advantages. The unique aspect is the method and apparatus of low pressure air mixing and pumping, described in a prior patent (ref to Megabubble mixer and airlift pump apparatus patent held by PBS).

What is claimed is:

1. A wastewater system comprising: a blower providing air to an aerator and a low pressure pulsed air mixer.

2. The wastewater system of claim 1, the wastewater system including a first stage tank, wherein the aerator is located in the first stage tank.

3. The wastewater system of claim 2, wherein the first stage tank is a biological oxygen demand zone.

4. The wastewater system of claim 2, wherein an additional aerator is located in a second stage tank.

5. The wastewater system of claim 4, wherein the second stage tank is an ammonia reduction zone.

6. The wastewater system of claim 4, wherein the low pressure pulsed air mixer is located in a third stage tank.

7. The wastewater system of claim 6, wherein the third stage tank is an anoxic zone.

8. The wastewater system of claim 7, further including a low pressure pulsed air pump.

9. The wastewater system of claim 1, wherein the low pressure pulsed air mixer is in one or more of a first stage tank and a second stage tank.

10. The wastewater system of claim 1, further including a low pressure pulsed air pump.

11. The wastewater system of claim 10, wherein the low pressure pulsed air pump pumps fluid from a treatment zone or clarifier zone to another zone.

12. The wastewater system of claim 1 wherein the aerator is located in an oxygen-rich zone.

13. The wastewater system of claim 12, further including an additional low pressure pulsed air mixer in the oxygen-rich zone.

14. The wastewater system of claim 11, wherein the low pressure pulsed air pump pumps fluid to an anaerobic zone.

15. The wastewater system of claim 1, wherein the aerator includes a plurality of air diffusers, wherein at least one of the air diffusers provide air to the lower pressure pulsed air mixer.

16. The wastewater system of claim 11, wherein the air diffuser providing air to the lower pressure pulsed air mixer is positioned between a support ballast and an open bottom portion of the lower pressure pulsed air mixer.

17. A wastewater system comprising: a blower providing air to an aerator; a low pressure pulsed air mixer and a low pressure pulsed air pump.

18. A wastewater system of claim 17 comprising of moving bed biofilm reactor (MBBR) process, with variable carrier element filling degree from 0-100%.

19. A wastewater system of single or multiple treatment zones of suspended, fixed or combined microbial processes, comprising: a blower providing air to an aerator and a low pressure pulsed air mixer.

20. The wastewater system of claim 19, the wastewater system including a first stage tank, wherein the aerator or low pressure pulsed air mixer, or both aerator and low pressure pulsed air mixer is located in the first stage tank.
